(19) United States
(12) Patent Application Publication
(10) Pub. No.: US 2004/0148233 A1
(43) Pub. Date: Jul. 29, 2004

(54) Methodology of performing double-entry bookkeeping on an internet based accounting system and producing accounting information online

(76) Inventor: Ho Ming Lee, Causeway Bay (HK)

Correspondence Address: ALIX YALE & RISTAS LLP, 750 MAIN STREET, SUITE 1400, HARTFORD, CT, 06103, US

(21) Appl. No.: 10/686,314

(22) Filed: Oct. 15, 2003

(30) Foreign Application Priority Data
Jan. 28, 2003 (HK) 03100701.7

(51) Int. Cl. G06F 17/60

(52) U.S. Cl. 705/30

(57) ABSTRACT

Methodology of performing double-entry bookkeeping on an internet based accounting system and producing accounting information online by means of the “six working pages—Data Capturer And Processor” which is capable of capturing transaction data remotely from each remote user of plurality of on line system users and remote communication between the server and user of plurality of on line system users. The “Data Capturer and Processor” is the core platform of an application program located at a server that is connected to a web IP address. The characteristics and working procedures of each page allow for bookkeeping complying with the technical rules of double entry account system and accounting principal on foreign exchange translation. The method supports the bookkeeping works and information system of a corporate with multi business units spreading all over the world. The method not only provides technical solutions encountering most of the shortcomings of carrying out bookkeeping in traditional ways, but also provides solutions to overcome well known obstacles in carrying out bookkeeping work in an internet communication environment.

### REFERENCE TO RELATED APPLICATIONS

The present application claims benefit 2003 under 35 U.S.C. §119 of Hong Kong Short-Term Patent Application No. 03100701.7 filed on Jan. 28, 2003.

### FIELD OF THE INVENTION

The present invention relates to bookkeeping and accounting information systems.

### BACKGROUND ART

Some semi-internet basis accounting programs are available in the market, which maintain users' databases at the server, but require the installation of a functions program and reporting tools into the computer of each user. This often requires payment for the license fee or purchase of each standalone program. However, it is neither convenient nor economical to install an accounting program on each user's computer, especially when the program is required to be periodically upgraded.

U.S. patent application No. 6,275,813 illustrates a method of recording and storing a double entry journal in database by keying “<”, a device with default meaning indicating the flow of assets, liabilities, income, expenses and capital.

U.S. patent application No. 5,390,113 illustrates a method of electronically performing bookkeeping which stresses the variations of data arrangement, sorting, preparation of account chart and preparation of financial information from a pool of electronic data.

Japanese Patent No. JP2001195521 illustrates a method of data synchronization with internet accounting system which stresses verification of journal entry and storing accounting data into an internet accessible database file.

### SUMMARY OF THE INVENTION

Briefly, the preferred present invention encompasses a method of data processing by the data capturer and processor composed of six working pages, with specific functions designed for each page, to carry out the double entry bookkeeping work. The functions are fit to a web-based internet communication environment. The invention provides solutions to overcome well known obstacles in carrying out bookkeeping work in an internet communication environment. The present invention encompasses a system that works with features of internet information technology to actualize remote and online accessibility at a centralized management information system.

An object of the invention is to perform online bookkeeping and accounting in a web-based internet environment, provide technical solutions to counter drawbacks of applying bookkeeping systems online and enable internet information technology to be applied to professional accounting.

An object of the invention is to provide a method of ensuring that all double-entry journals are stored in a database complying with the rule of Debit-Equal-Credit wherein every procedure is done and tested by the data capturer and processor and the tested, processed and completed data is then stored in a designated database by a single key stroke by the operator. An object of the invention is to protect database files against storage of a single-entry journal and the disorderly storage of a journal as caused by unpredictable disturbances occurring during data transmission over the web and unpredictable disconnection phenomenon associated with internet communication.

An object of the invention is to provide a practical solution to businessmen who work with accounting data and who switch between geographically separated stations.

A preferred invention utilizes a data capturer and processor for composing six working pages that perform most of the technical parts (groundwork) of general double entry bookkeeping and which will generate full books of accounts.

The core program performs most of the technical works required for a comprehensive bookkeeping and accounting system, such as posting closed balances from current year so as to become opening balances of next year. A reports editor is included in the program. The editor facilitates retrieval of processed data from the database and transformation of the data into enabling management financial information and reports which can be sent to multiple users on separate stations for analyst use and output of results.

An object of the invention is to provide transaction-oriented working pages annexed with combo lists (listing of selected permanent data sets for bookkeeping purposes), explanation labels and the logical arrangement of input cells, to allow users with limited accounting knowledge to follow the procedures as instructed whereby they may input data for the program to carry out bookkeeping and accounting work. Users need not memorize all the accounting theories nor be professionally trained to perform such work and thus the program can minimize the probability of erroneous entries in the debit or credit side during bookkeeping process.

### DESCRIPTION OF THE DRAWINGS

FIG. 1 illustrates the mechanism of bookkeeping and accounting information system working in parallel to online web based communications consistent with the present invention.

FIG. 2 is a flowchart for generating financial reports from a plurality of user journals stored in a designated database file.

FIG. 3 illustrates a method of performing bookkeeping with the Data Capturer and Processor consisting of six working pages having a set of specific procedural steps for converting transaction data of a specific type into a double entry journal.

FIG. 4 is an extension of FIG. 3, illustrating the method of calculating the exchange difference derived from foreign currency transactions, and building up an exchange record-set for posting the amount of the difference into and incorporating exchange record-set into the transaction record-sets group.

FIG. 5 is an extension of FIG. 3, illustrating the method of processing a transaction set, consisting of several sets of transaction data, by repeating the procedures described in FIGS. 3 and 4.

FIG. 6 further elaborates the procedure in FIGS. 3 to 5 are applied in JJ page which is structured with an add-in feature of dummy record set for performing bookkeeping works of general type transactions.

FIG. 7 further elaborates the method of fitting the System into the internet communication environment.

FIG. 8 illustrates the method governing the access rights of users to the System and to a particularly designated database file.

FIG. 9 illustrates the method governing the access rights and levels of users within a corporation to the system and the designated corporate database file.

FIG. 10 shows examples of double entry journals worked out by working pages as described in FIGS. 3 and 4.

FIG. 11 illustrates an example of double entry journal, record sets, worked out by working pages as described in FIGS. 3, 4 and 5.

FIG. 12 illustrates an example of a double entry journal, record sets, worked out by working pages as described in FIGS. 3, 4, 5 and 6.

FIGS. 13-18 depict the user interface of Pages AR, AP, Rec, Pay, TT, and JJ.

FIG. 19 depicts an example of voucher feedback as displayed to a user inputting the data immediately after each set of transaction data has been processed.

FIG. 20 is an example of a financial report generated by the report editor of the system.

FIG. 21 depicts the user interface of the working platform.

FIG. 22 depicts rules for amount in local currency recorded.

FIG. 23 depicts the user interface of a page for use by an internal/external auditor.

### DETAILED DESCRIPTION

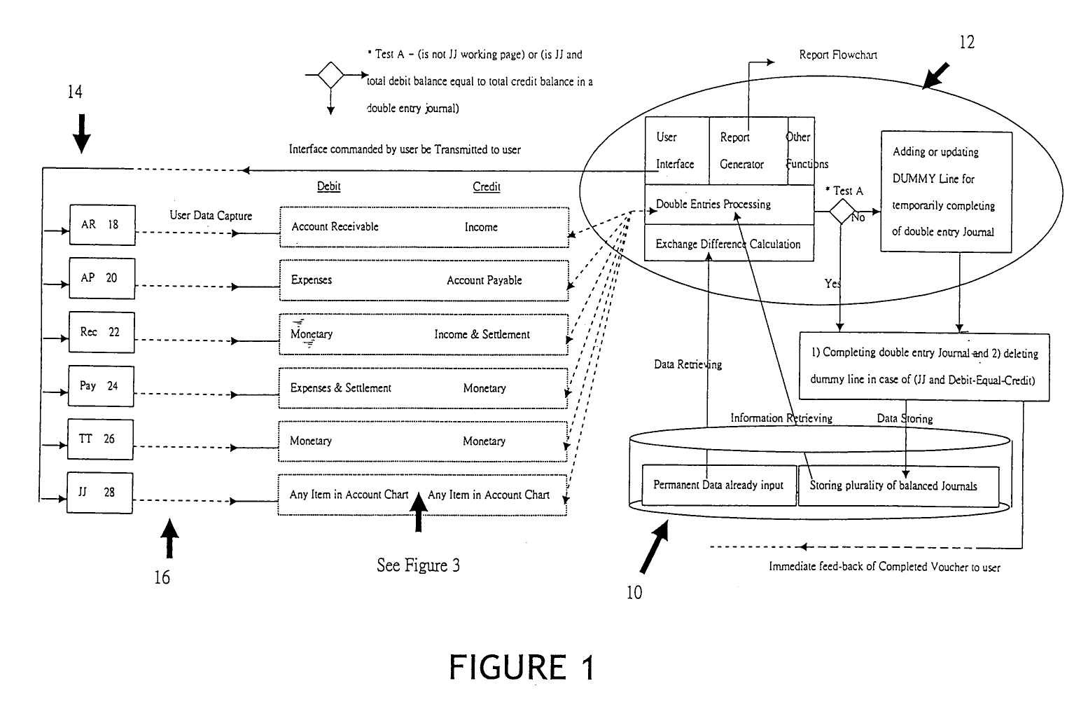

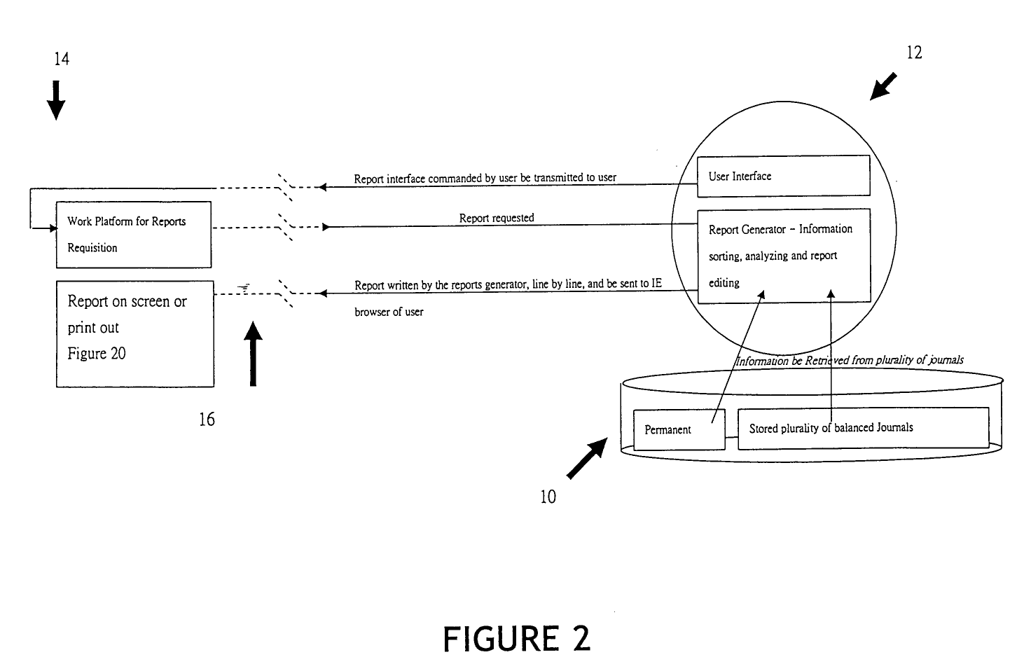

An embodiment of the present invention is the method of carrying bookkeeping in an internet communication environment as illustrated in FIG. 1. The bookkeeping program complies with the theories of double entry accounting and can be carried out by users with various levels of accounting knowledge. A plurality double entry journals being completed can be stored up in the designated database file 10 associated with each individual registered user. The stored data is then used for producing information and generating reports. (See FIG. 2.)

The functions program 12 and the plurality of user database files are located at a remote server. Each of the plurality of users utilize a work platform 14 such as a general-purpose computer linking to the Server system at a remote end through an internet connection 16.

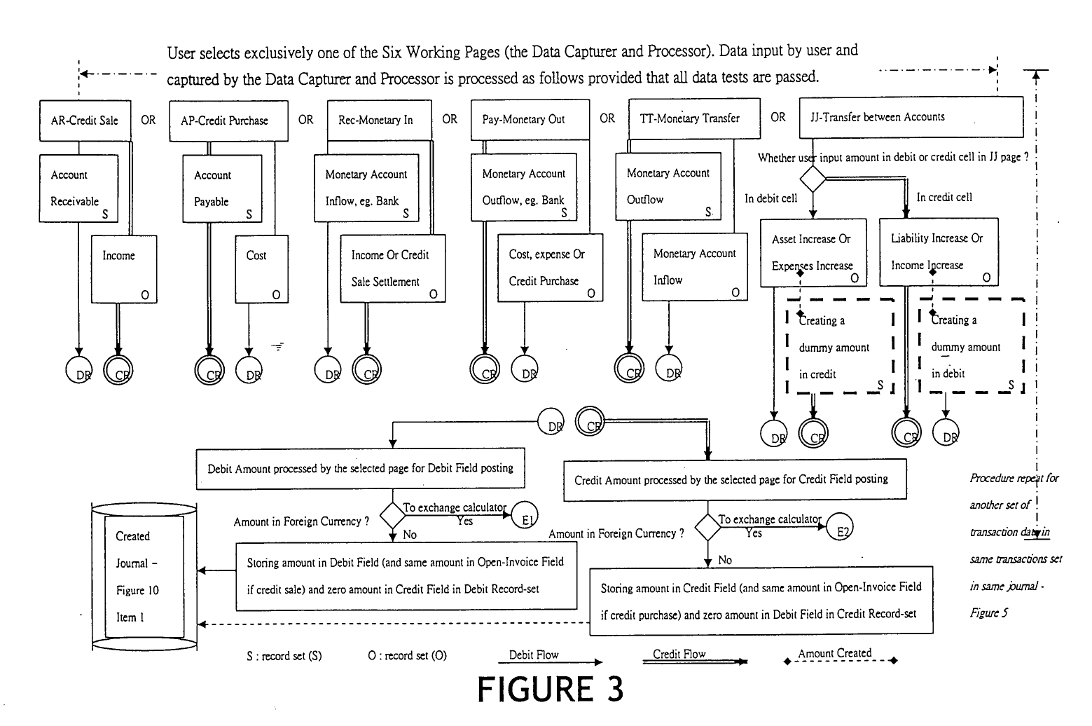

In an embodiment of the invention, the data capturer and processor produce the six working pages which correspond to accounts receivable, accounts payable, receipts, payments, transfer transactions, and general transactions. These are respectively the AR 18, AP 20, Rec 22, Pay 24, TT 26 and JJ 28 pages. The processing procedures of these pages are shown in FIGS. 3-7. For example, user selects an appropriate working page according to the specific type of transaction required for input. For instance, page AR may be selected for a credit sale transaction.

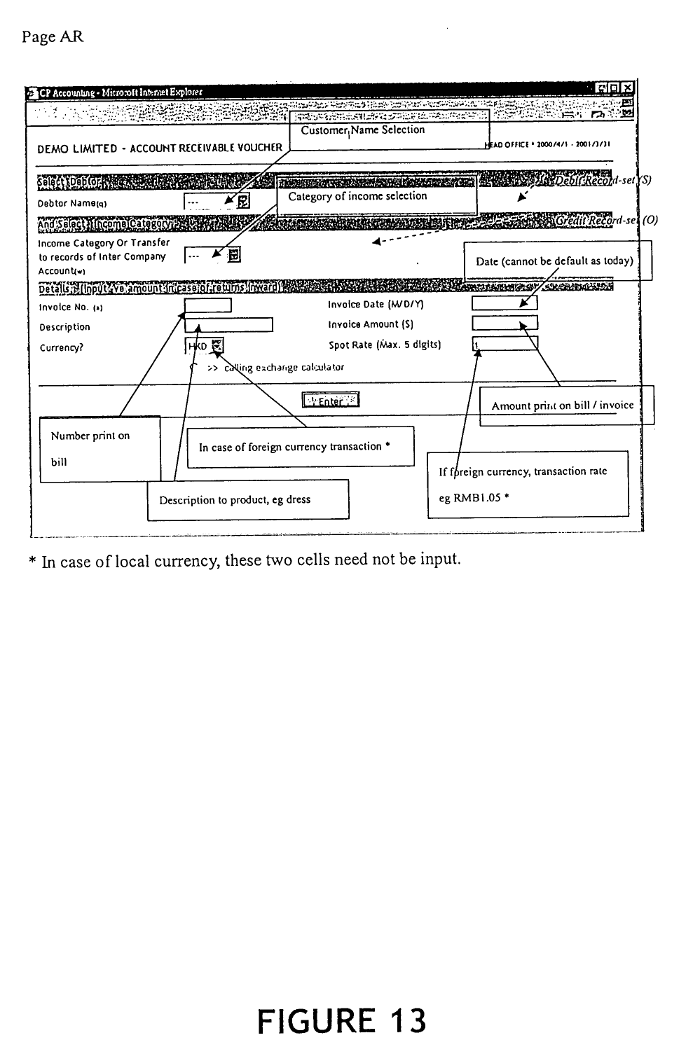

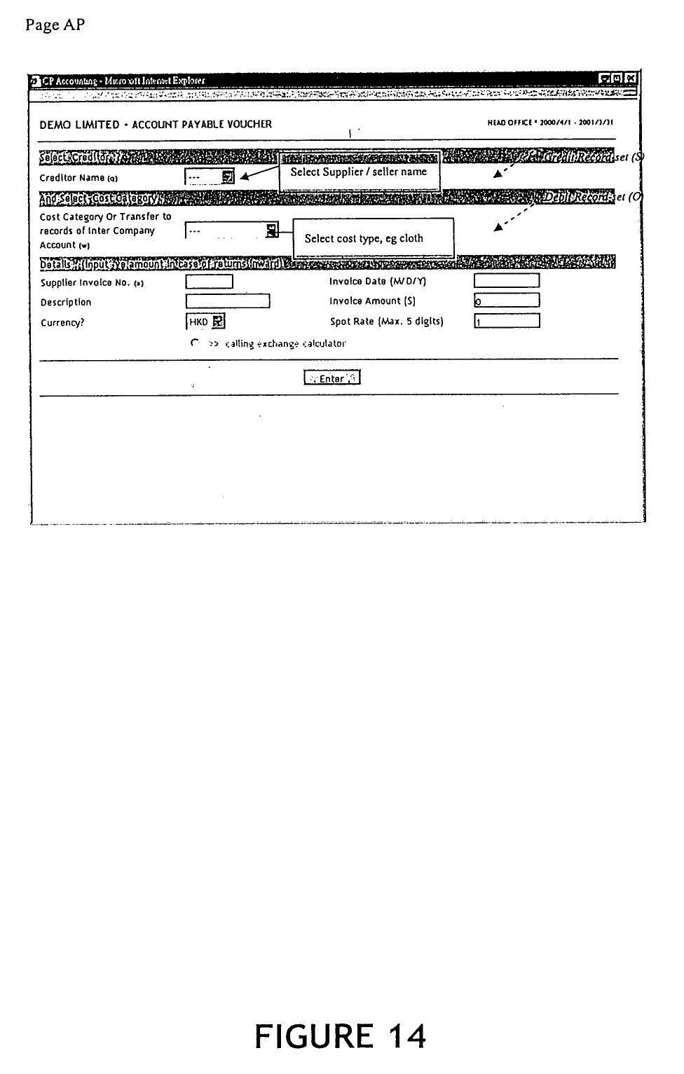

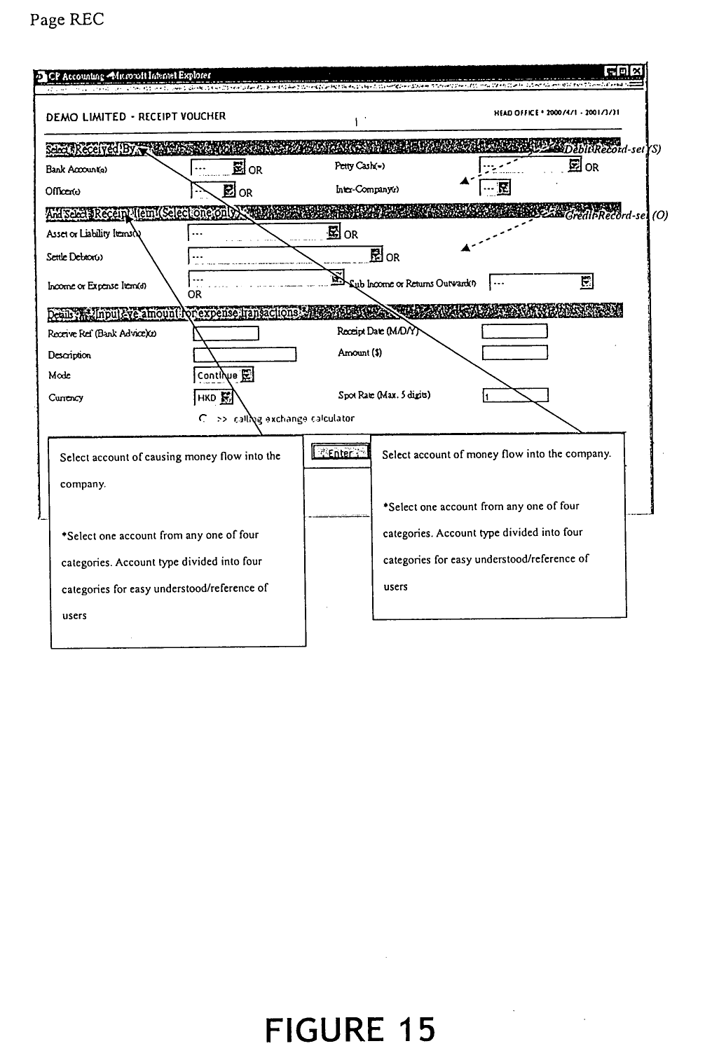

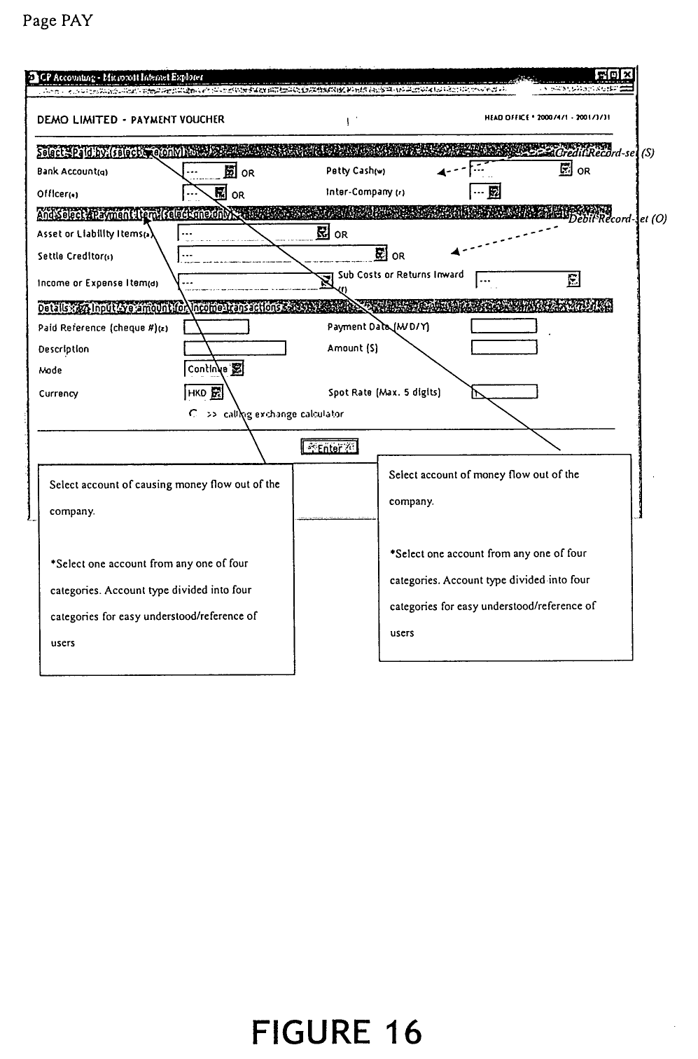

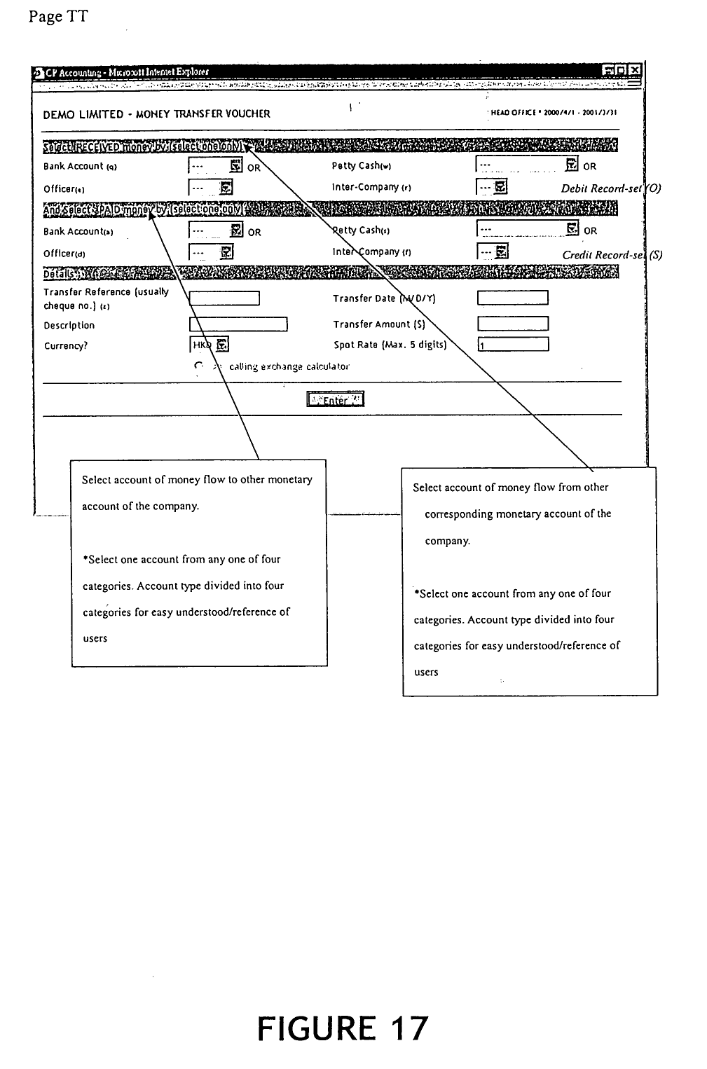

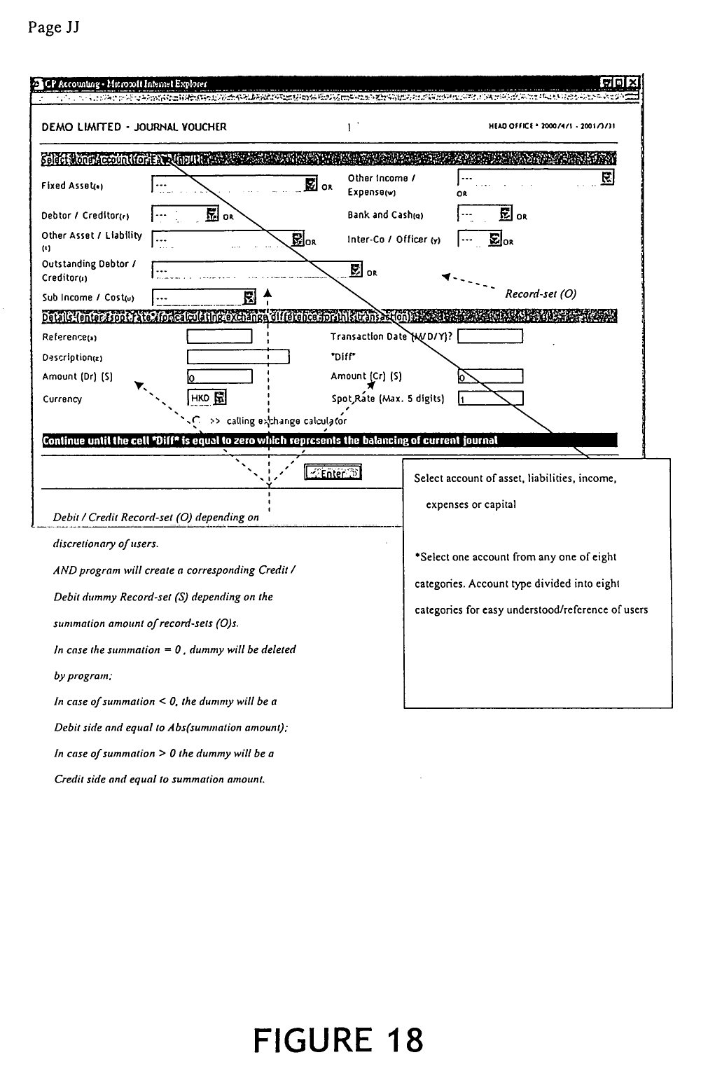

Each page contains pre-set instruction and/or signals, FIGS. 13-18, wherein users follow the indication or other guiding instructions/wordings pre-set on each page to input each set of transaction data and press “enter” when complete. Everything goes automatically according to the steps illustrated in FIG. 3. For example, in page AR as shown in FIG. 13 data such as invoice number, description, invoice date, invoice amount and spot rate is entered by the user using data input from, for example, a keyboard, voice recognition system, and data transfer from external device. Some information may be simply selected from a combo list such as for customer name selection, income category and type of currency.

For a new transactions set to be input, the user selects exclusively one of the six pages. Once the page is selected and opened for user's data input, no other page can be opened before the selected page is closed. No two or more pages work simultaneously in same platform. The transaction amount to be entered into the journal according to the rules pre-set by each of the Six Working Pages is arrived at through the processing of transaction data input by the user into that selected page.

If the entered data meets the required tests such as form, completeness, and other data integrity tests, the debit amount is then sent into the debit flow pathway DR wherein the amount entered into the journal is arrived at through the processing of transaction data set entered into the selected page by the user. The amount to be sent to the pathway DR will be account receivable from the AR page; cost from the AP page; monetary account inflow from the Rec page; cost expense or credit purchase settlement from the Pay page; monetary account inflow from the TT page; or asset increase or expense increase or dummy amount from the JJ page. The determination is made as to whether or not the amount is in foreign currency. If the amount is in foreign currency then the amount is processed by the exchange calculator. The amount is then stored in the debit filed in the debit record set wherein zero is stored in the credit field.

The credit amount in contrast to the debit amount enters the credit flow CR wherein the amount entered into the journal is arrived at through the processing of transaction data entered into the selected page by the user. The amount to be sent to the pathway CR will be income from the AR page; account payable from the AP page; income or credit sale settlement from the Rec page; monetary account outflow from the Pay page; monetary account outflow from the TT page; or liability increase or income increase or dummy amount from the JJ page. The determination is made as to whether or not the amount is in foreign currency. If it is, then the amount is processed by the exchange calculator. The amount is then stored in the credit field in the credit record-set wherein zero is stored in the debit field.

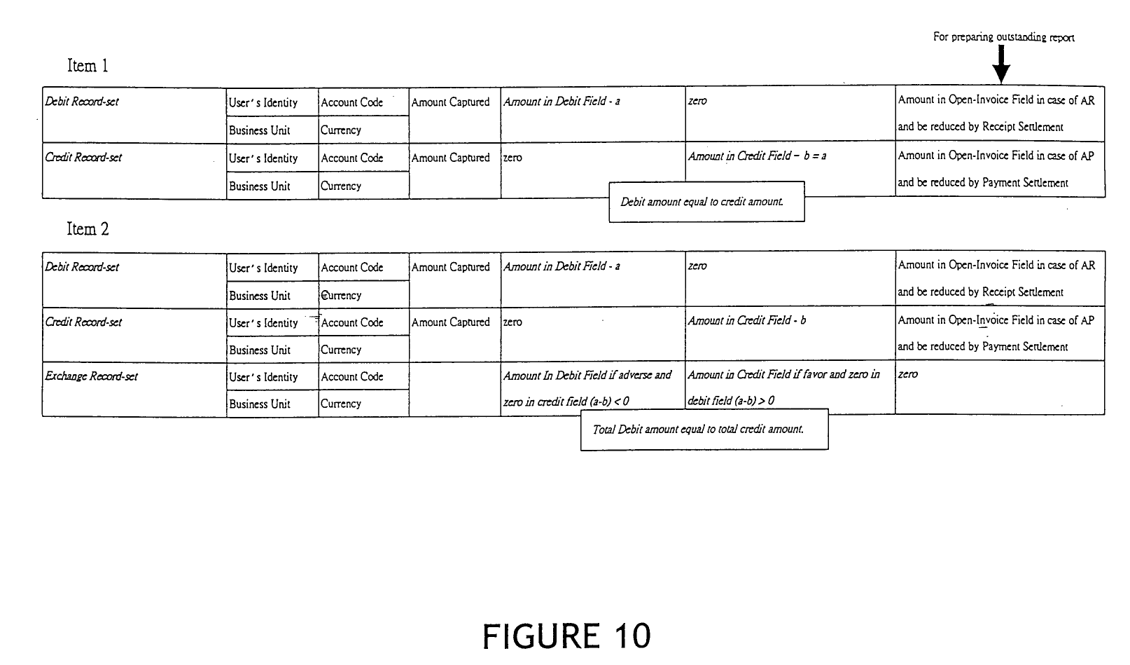

Having been processed by the program, the captured data is simultaneously converted into two record-sets, one set carries an amount in debit field and zero in credit field and the other carries amount in credit field and zero in debit field. Processed data are stored in double entry journal form as shown by Item 1 of FIG. 10.

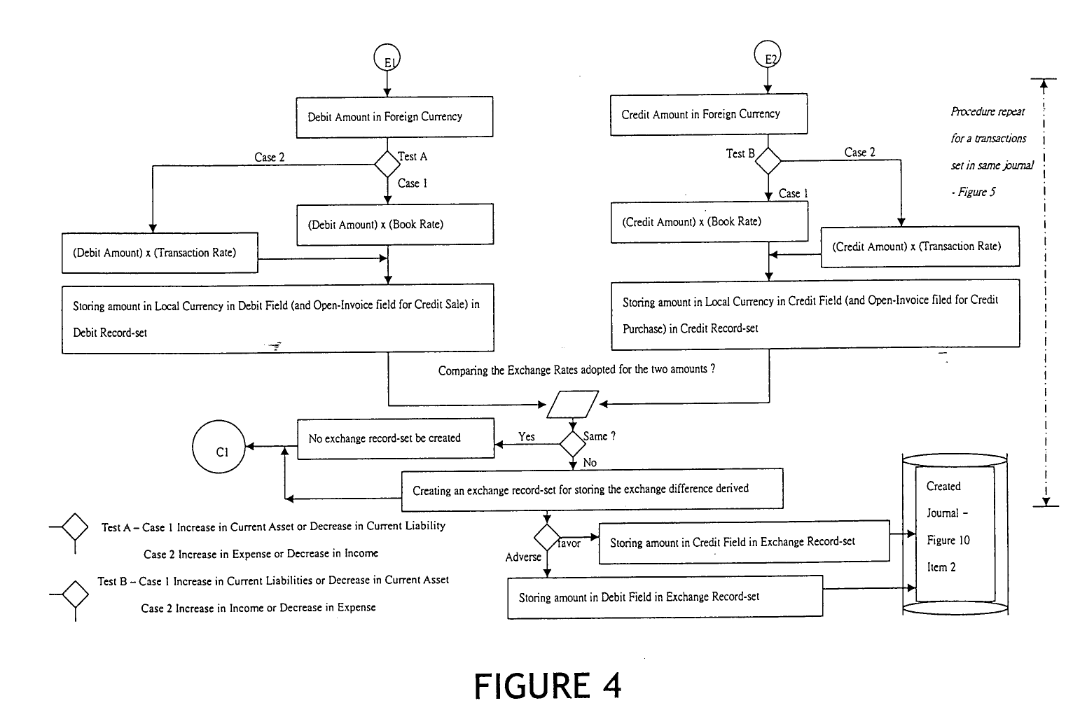

In case of a foreign currency transaction, the procedures are illustrated in FIG. 4 and the accounting principle of “foreign exchange translation” is applied by, for example, translating the amount of foreign currency into local currency. In the case of the transaction involving the account under the categories of Current Assets and Current Liabilities, the amount in foreign currency is translated to local currency by adopting the book rate, otherwise, adopting the transaction rate. An exchange record-set is built up for recording the exchange difference resulting from adopting different rates to amount in debit record-set and amount in credit record-set. The amount of exchange difference in exchange record-set is stored in debit field/credit field exclusively in case of adverse/favor exchange derived from.

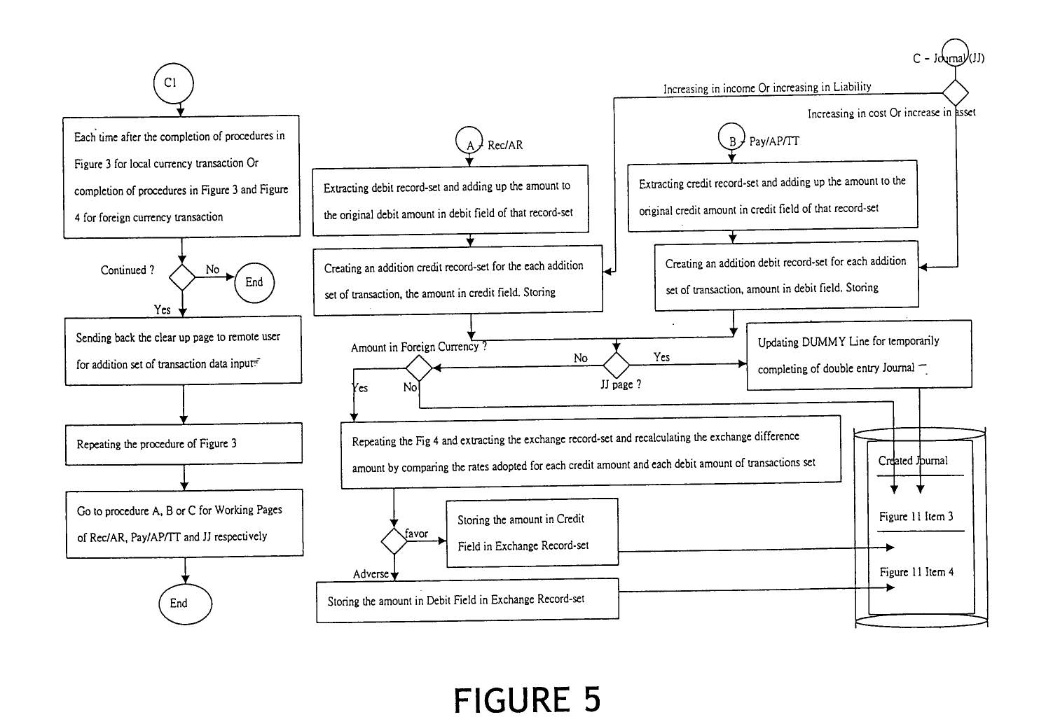

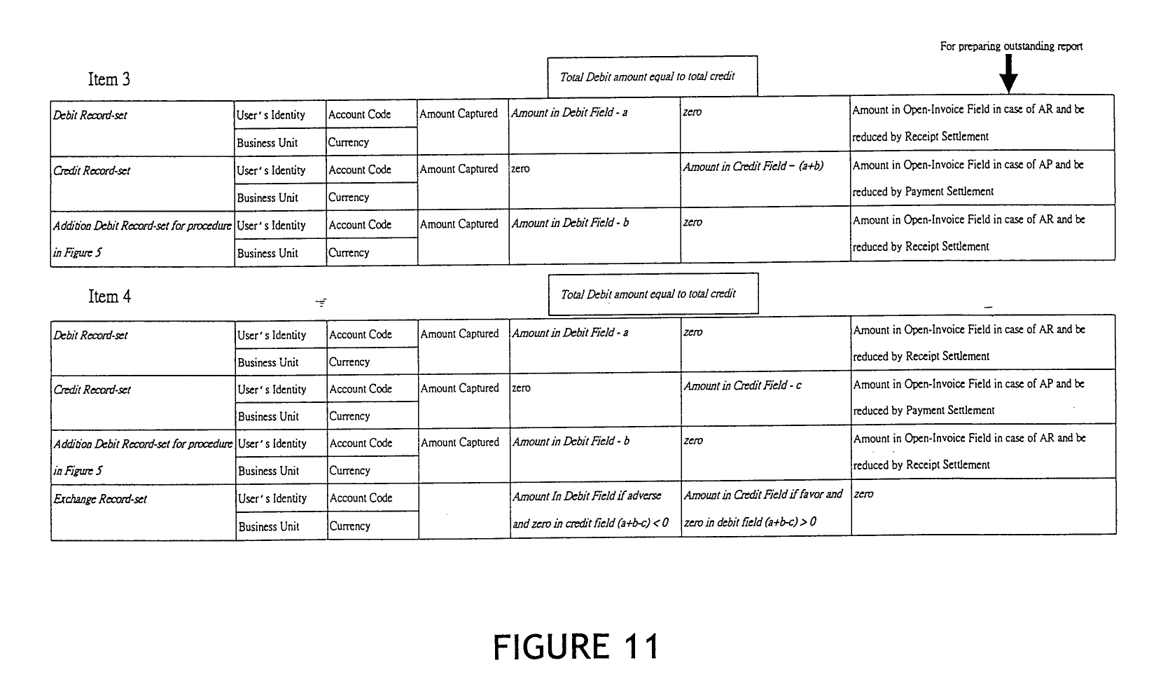

Each working page is capable of being recalled for processing on multi transactions set in FIG. 5. The process of recording each set of transaction data in a transactions set is repeated as shown in FIG. 5 together with FIGS. 3 and 4 until the user sends the “End” command. A set of record-sets group is, for example, built up as in FIG. 11, Item 3 and Item 4.

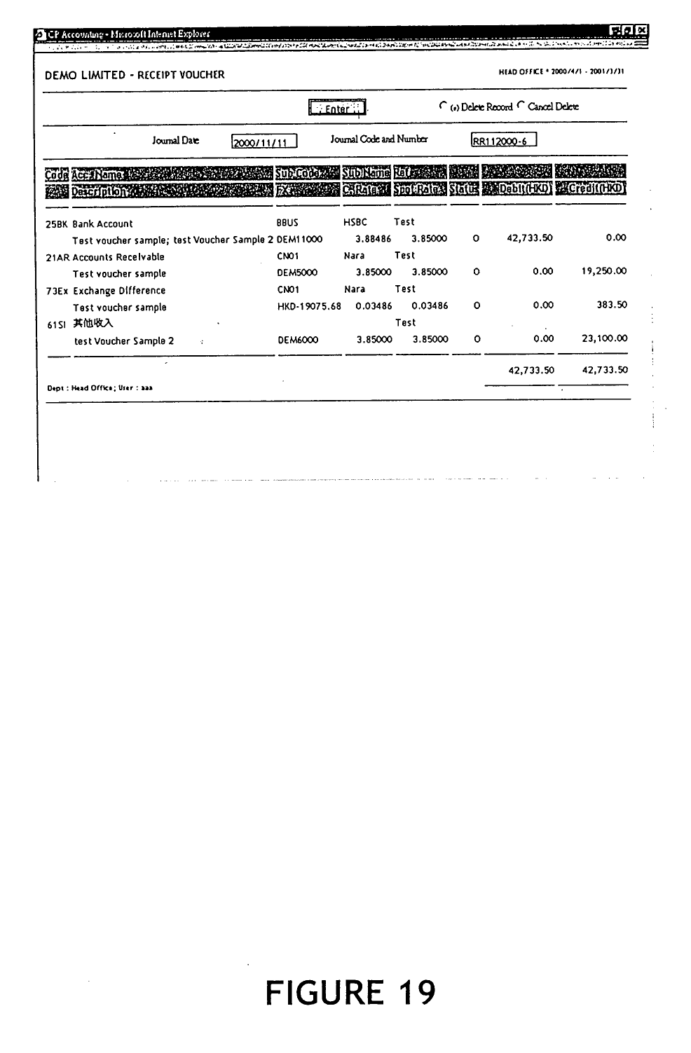

As each set of transaction data is being processed, a voucher as known in general accounting practice and shown in FIG. 19, is prompted to users for reference on real time basis.

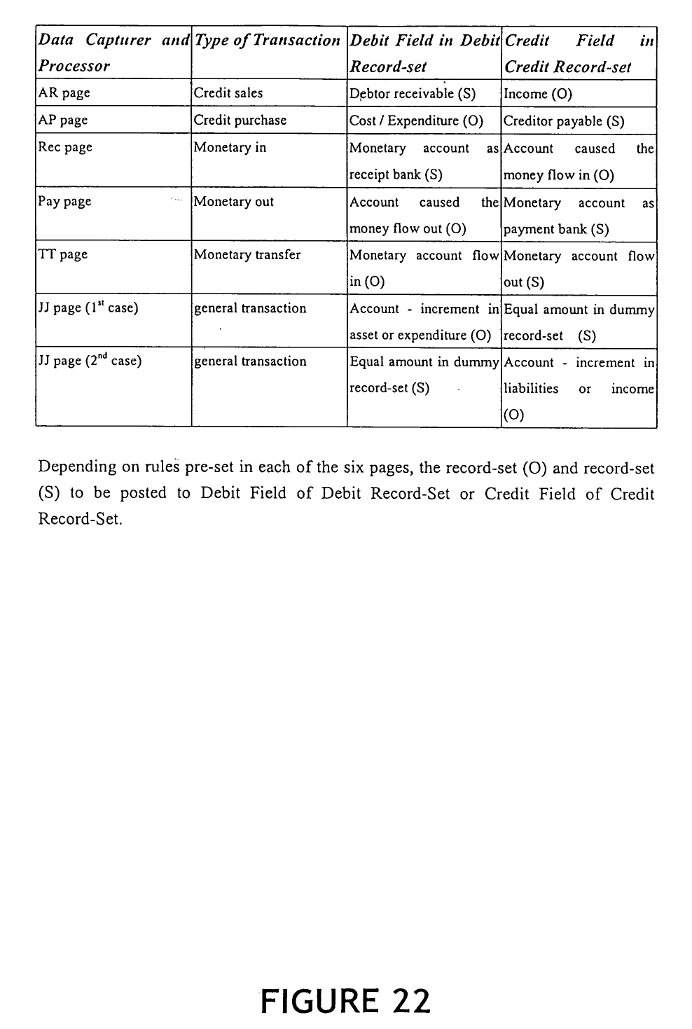

According to each of the working pages, the amount in local currency is recorded in the debit field or credit field for each record-set complying with the rules shown in FIG. 22.

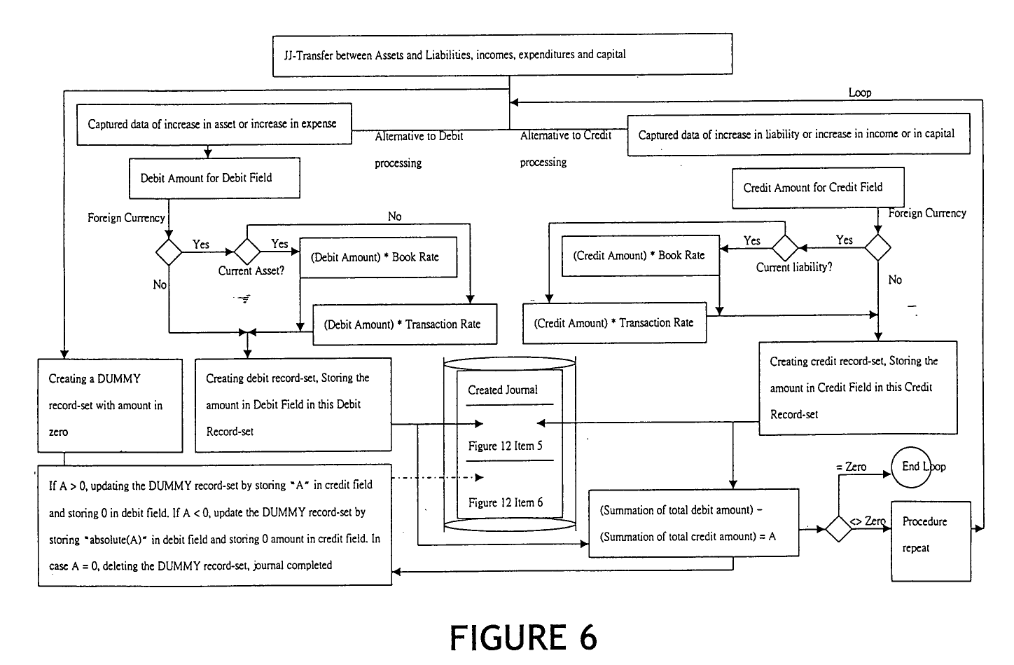

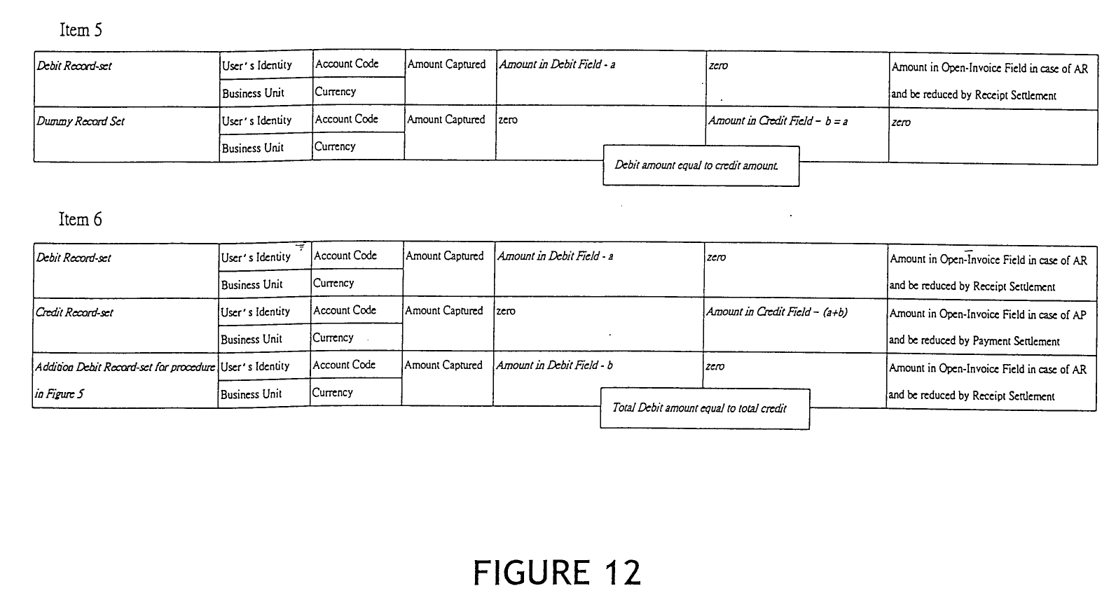

With regard to the JJ page 28, recording in general transaction, this page is constructed for some transactions in which the users determine the debit entry or credit entry of a transaction data set. In case of debiting the selected account for an increase in asset or increases in expense or decrease in liability or decrease in income, a dummy amount (equal to debit amount) is credited to a dummy record-set. In case of crediting the selected account for an increase in liability or increase in income or decrease in asset or decrease in expense, a dummy amount (equal to credit amount) is debited to a dummy record-set. Repeating the procedure as illustrated in FIG. 6, for each additional set of data processing, the dummy account will be updated. Dummy record-set will be automatically deleted in the case of when the total debit amount equals to total credit amount, that is, the amount in dummy account becomes zero. The journal entry is completed as shown in Items 5 and 6 of FIG. 12.

Each double entry journal must at least be composed of two record-sets: one for recording an amount in debit field and one for recording an amount in credit field.

For each transaction data set, the user has to fill in some relevant cells in the selected working page, including:

1) Combo(s) for listing name for Subject(S) e.g. Selecting from Customer combo of name of subject: say customer name;

However, this cell is not necessary for JJ page as user determines the debit or credit amount to be recorded in next transaction data set. Whereas, Dummy Record-set is regarded as (S).

2) Combo(s) for listing name for Object (O) the Account transaction related to this subject e.g. Selecting from the Income Combo of Account Name—say Overseas Income.

3) Cell for inputting the date of the transaction.

4) Combo for listing the currencies—say selecting USD for this transaction.

5) Cell for inputting the amount in currency selected in the Currency combo.

6) Cell for inputting the currency rate of foreign currency transaction—for example, 7.78 for a transaction in United States dollar whereas local currency is in Hong Kong dollar.

All the above data will post accordingly information of the record-sets group FIGS. 10, 11 and 12.

According to the above information together with some data extracted from permanent files of that particular user (the permanent file is built up at first use of the system for storing some data in general use of that particular user), the data is processed from FIGS. 3 to 4; a journal is completed as shown in FIG. 10, Item 2 and will then be stored in the database file. In case of transactions set to be processed as FIG. 5, a journal is completed as shown in Item 4 of FIG. 11 and, in case of the transactions set to be processed by JJ page as in FIG. 6, a journal is completed as shown in FIG. 12, Item 6.

Included in each working page for bookkeeping, there are some testing functions for ensuring the integrity of data which is to be stored in the database file. The testing functions in an embodiment of the invention are:

Date Test for ensuring the processed data are recorded in a table of the appropriate year;

Format Test for ensuring the input of data is in correct format;

Input Completeness Test for ensuring all the necessary data of a transaction is filled fully and logically in input cells on each page;

Debit-Equal-Credit Test for ensuring the debit amount in a double entry journal must be equal to the credit amount of that journal;

Each transaction data set is subject to all the above tests. If any one of these tests is not passed, the input of that data set will be rejected. The working page will be cleared up and user will be prompted for re-entry. The reason of the entry failure will be stated as hints in the hints cell on each working page and may indicate the nature of the failure in addition to possible remedies or solutions.

As the program is working on a web-based internet communication channel, there is an additional feature in the page JJ for recording the transferred of assets, liabilities, incomes, expenditures and capital accounts as further elaborated and shown in FIG. 6. A dummy record-set is added to the journal every time a new journal is created and updated while another set of transaction data will be added to the journal. The amount for dummy record-set is equal to the difference between the debit amount and credit amount of the transactions set. The function of this is to balance the open journal before the journal is completed, thereby protecting against a disconnection from web communication that might cause an open journal not yet having been balanced to be stored in database. The program will automatically delete the dummy record-set after the total debit and the total credits are checked to be equal. If the connection is interrupted, the dummy record-set can be drawn back from database for editing after the recovery of the communication connection.

A method according to an embodiment of the invention may first create a user interface having a data capturer and processor which composes AR; AP; Rec; Pay; TT; and JJ working pages, respectively, for performing or capturing transactions data of credit sale; credit purchase; monetary receipt; monetary payment; monetary transfer; and general transactions, which is able to be sent to the user for inputting transactions data. This may be followed by capturing data on each working page, and then clearing up necessary input cells accordingly before sending to the user for further input of additional transaction data in the same transactions set. A set of procedural steps may then be employed on each of the working pages wherein there is an automatic creation of a record-sets group with at least two record-sets, one for recording processed data of debit record-set and one for recording processed data of credit record-set; depending on the features of each of the working pages, one of the record-sets is created as “subject (S)” and the other as “Object (O)”. Each record-sets group may have only one (S) with unlimited number of (O); according to the specific procedures of each page, a transaction amount is either posted into the debit field or posted into the credit field of each record set exclusively, either debit record-set or credit record-set created as (S) and (O) follow the rules for debiting and crediting in each working page; any additional transaction data in the same set will simultaneously update the transaction record-set (S) of the record-sets group and create a new record-set (O) incorporating into the record-sets group record-sets group as a whole to constitute a double entry journal while complying with the Total-Debit-Equal-Total-Credit rule throughout.

The record-set may then be defined as (S) and record-set as (O) by the rules of each working page wherein record-set (S) and record-set (O) are built up based on transaction data; except for page JJ which records general transactions and record-set (S) is built up with special purpose.

Next a dummy record-set may be created with the JJ page as (S) for temporarily balancing the record-sets group. This dummy record-set may be needed because the next set transaction data to be input is not anticipatable to the program wherein the function of (S) in JJ page is for protection of database files from recording record-sets group of single entry or disordered journal entries caused by disturbance or disconnection during the transmission of data and once the total debit is equal to the total credit in a same record-sets group, the (S) will be automatically deleted by the program to ensure all processed data stored into the database are double-entry journals.

Depending on whether foreign currency is involve conversion into local currency may take place. The conversion may adopt the appropriate exchange rates wherein the application of the function “exchange difference calculation” is included in each working page and is based on the “principal of translation of foreign currency transaction” according to general accounting practice, enabling an automatic creation of a new record-set (E) for recording data resulting from an exchange difference derived between the adoption of book rate and transaction rate according to account types involving in the record-set (S) or (O) or vice versa so that the debit or credit balance in (E) corresponds to the adverse or favor difference derived and for each additional data set be processed, this procedure repeats and updates the amount of exchange difference in existing record-set (E).

The full procedural steps may then be executed the Debit-Equal-Credit test of each working page when a new record-sets group “(S) plus (O)” is created or an additional transaction record-set (O) is added, the program regarding each as a separate process of the data set.

The double entry journal may then be converted into a voucher form which will take place every time following each separate process completed as stated previously.

The voucher may then be transmitted or feed back to the user on a real time basis every time completion of a process as stated previously is done as to a particular user inputting transaction data.

The double entry journal may then be stored which is comprised of record-sets group whereas each record-set consisting the identification fields of user's identity and user's business unit; account codes; input amount; currency; the converted amount in local currency in debit field or credit field; open invoice amount in case of credit sale or purchase transaction.

The record sets group may then be stored or updated in the form of double entry journal into the designated database file in one stoke immediately after each processing wherein access is given only to an identified user wherein the user is identified through the identification fields for the user's access right and the limitations set by the program on the usage of database file be kept intact.

Finally, the reporting command may be received from each of plurality of users and then by reference to the user's identity and business unit, sorting, working out and analyzing on each of the plurality of journal records retrieved, sending out financial reports in general accounting practice and analysis to the user by way of report editor that writes report line by line word by word to the user's browser.

In an embodiment of the invention, the six working pages may have a distinguishable relationship between the transaction type and account type for debit or credit field and accordingly there is a set of standard processing procedural steps to work out the double entry journal; a double entry journal has been completed whereas the summation of all debit amounts in debit record-sets equals to the summation of all credit amounts in credit record-sets in same record-sets group:

| | |
|---|---|
| Page AR | Relationship between debiting credit receivable (S) |
| | and crediting income (O) for credit sale; |
| Page AP | Relationship between crediting credit payable (S) |
| | and debiting cost (O) for credit purchase; |
| Page Rec | Debiting monetary flow-in (S) and crediting income |
| | (O) or customer invoice settlement (O) for receipt |
| | transaction; |
| Page Pay | Crediting monetary flow-out (S) and debiting cost (O) |
| | or debiting supplier invoice settlement (O) for |
| | payment transaction; |
| Page TT | Crediting monetary flow from one monetary item (S) |
| | and debiting monetary flow to another monetary item |
| | (O) for monetary transfer transaction; |
| Page Journal | Dummy record (S) in debit/credit field and |
| | corresponding amount in credit/debit field of record- |
| | set (O) of general transaction causing change in |
| | asset, liability, income, expense or capital account. |

When additional transaction data set is processed, a new record set (O₂) may be created wherein the existing record-sets group of same record-sets group posted previously is brought back from the database file and be updated as follows:

amount in existing Record set (O₁)=A;

amount in existing Record set (S₁)=B;

amount in existing Exchange record set (E₁)=C;

amount in new record set (O₂)=D;

amount of newly derived exchange difference for adding into (E₁)=E;

amount of newly created for adding into Record set (S₁)=F;

if A+C+D+E=B+F, test pass;

the record-sets group will then be updated and the journal will have the following:

record set (O₁) with amount A;

record set (S₁) with amount B+F;

record set ((E₁) with amount C+E;

record set (O₂) with amount D.

The six working pages included in the data capturer and processor cover the comprehensive procedures of carrying out bookkeeping work for general purposes as shown in the art. However, it is capable for further development by adding some functions to these six pages for some specific type of business. For instance, adding a selection combo of visa type linking with bank account on page of AR and adding a selection combo list of stock items in pages of AR and JJ, the program is also capable of being utilized by retail business.

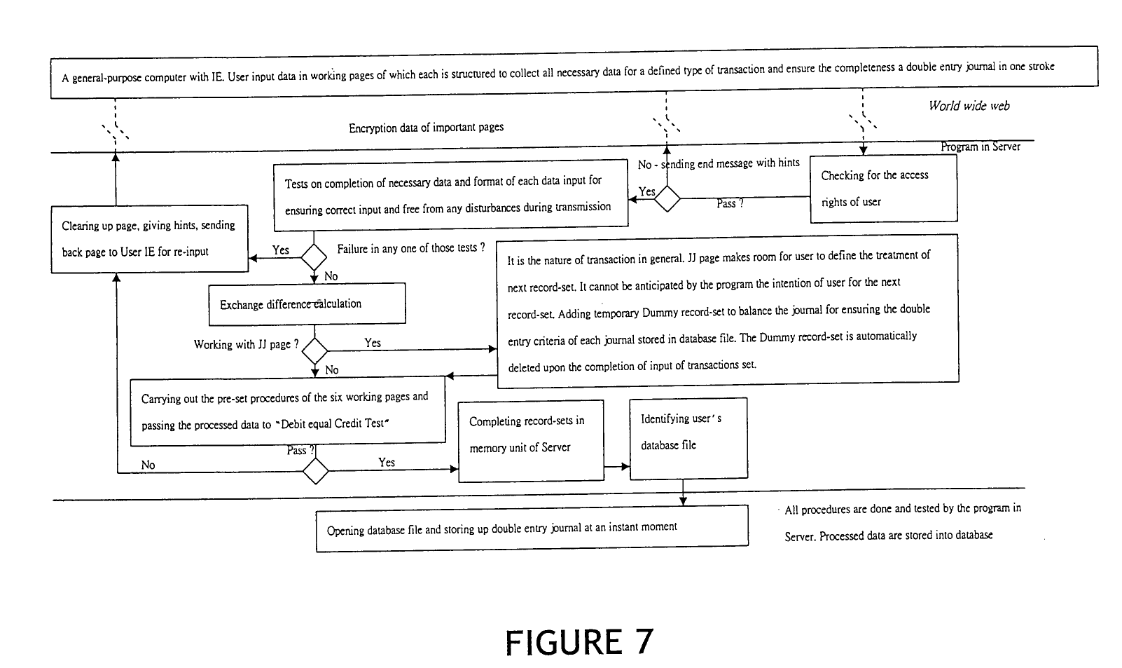

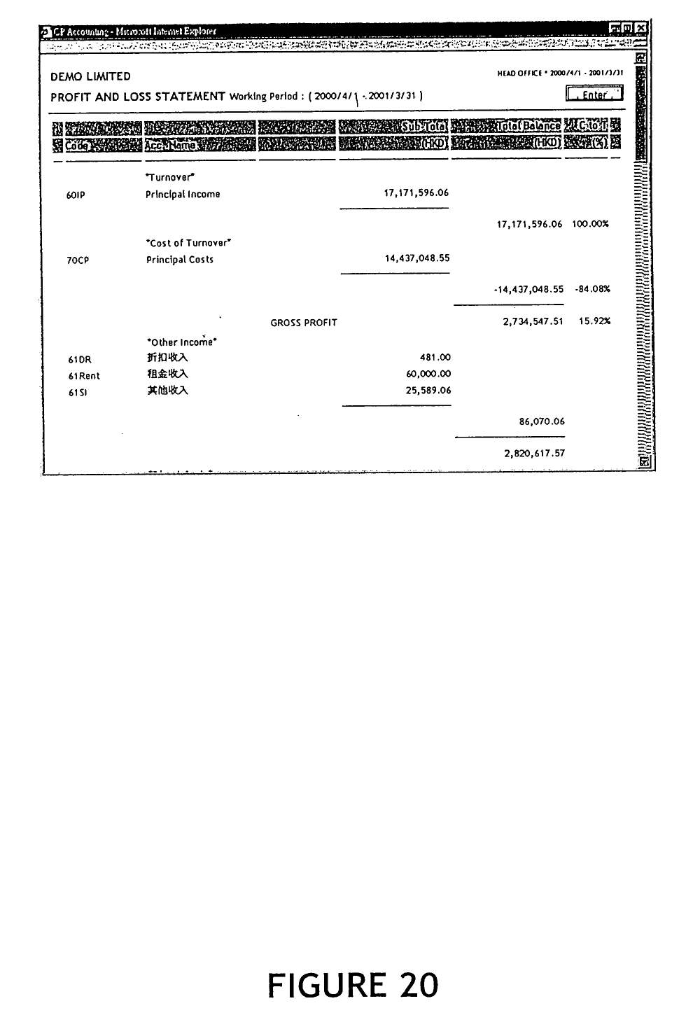

A plurality of journals stored in the database can be retrieved for future usage of reporting in an embodiment of the invention. According to the selection criteria and report types selected by the user, different combinations of processed data can be sorted out from the journal storage which being constantly added by the above-mentioned bookkeeping work as shown in FIG. 7, together with the accounts chart the framework for presentation of the financial statement and the permanent data, such as customer data pool, currency rate pool, etc, forming a full picture depicting the results in FIG. 20 and state of affairs of the business of each of plurality of users. Furthermore, other reports for managerial and controlling purpose are available, for example, aging; outstanding and movement reports of debtors, creditors, and stock; payment register, and non-current assets register.

The methodology of generating reports of the reports editor in the program is for example to line by line write the processed information to the web browser of each of a plurality of users and not pass through any of reporting tools. An example of a report is shown in FIG. 20.

Further, functions may be annexed to the preferred embodiment in order to make the management information system working more effective and efficient.

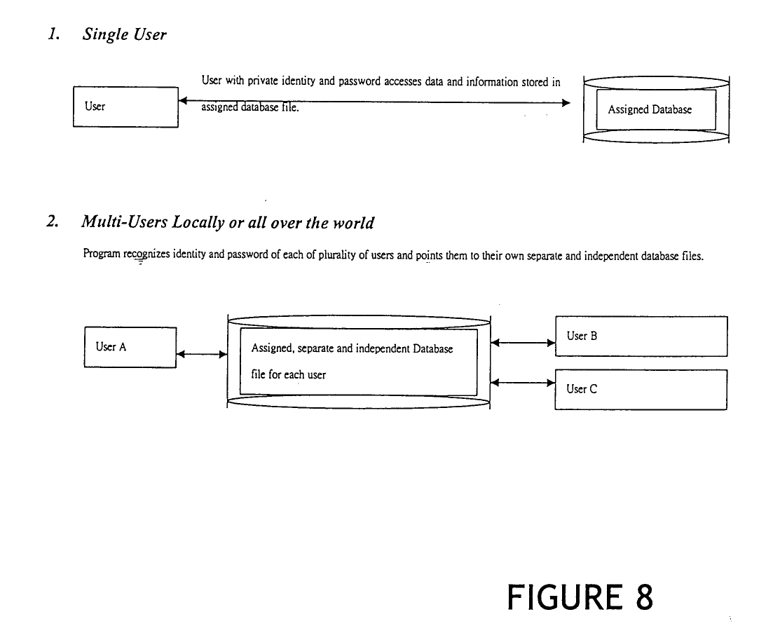

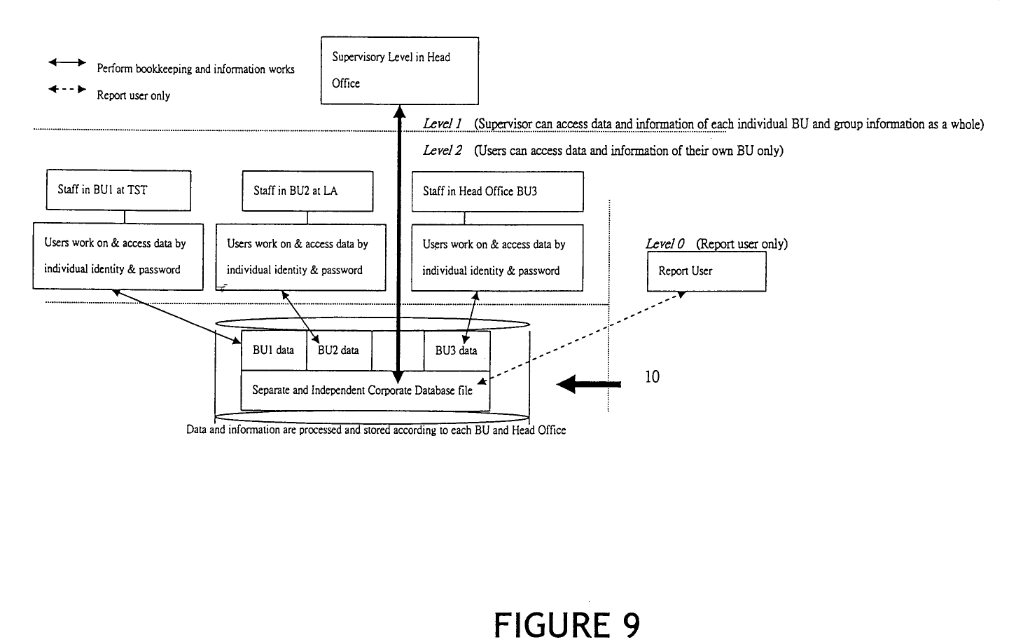

As illustrated in FIGS. 8 and 9, the system not only supports multiple users at remote locations, but also supports corporate users with multiple branches located locally and globally. For example, users A, B and C may be separated geographically by great distance. Each branch (referred to as BU) maintains its own sets of operation and financial information. Results of all branches are often required to be consolidated at a Head Office or other site. Each user can be identified by differentiation of user specific information to assign variable access to the system. The system may verify such things as users' identities, passwords and business unit and provides, for example, three levels of access rights as shown in FIG. 9 to each user in a corporation as follows:

Level 0—user of this level reads financial information only and will not involved in any of the bookkeeping work. They might be a decision-maker who needs the information for and during meeting in any location.

Level 1—user of this level may be engaged in the supervisory work on all branches of the corporation. User can read the combined financial information of all branches as a whole and read the financial information of each branch individually.

Level 2—users of this level may be engaged in the bookkeeping work at each branches of the corporation. They can read the financial information of their branches they are working for.

An individual and independent database file is assigned for each of the plurality of users in order to reduce the possibility of misplacement of data and protect other users from any malfunction caused by improper user.

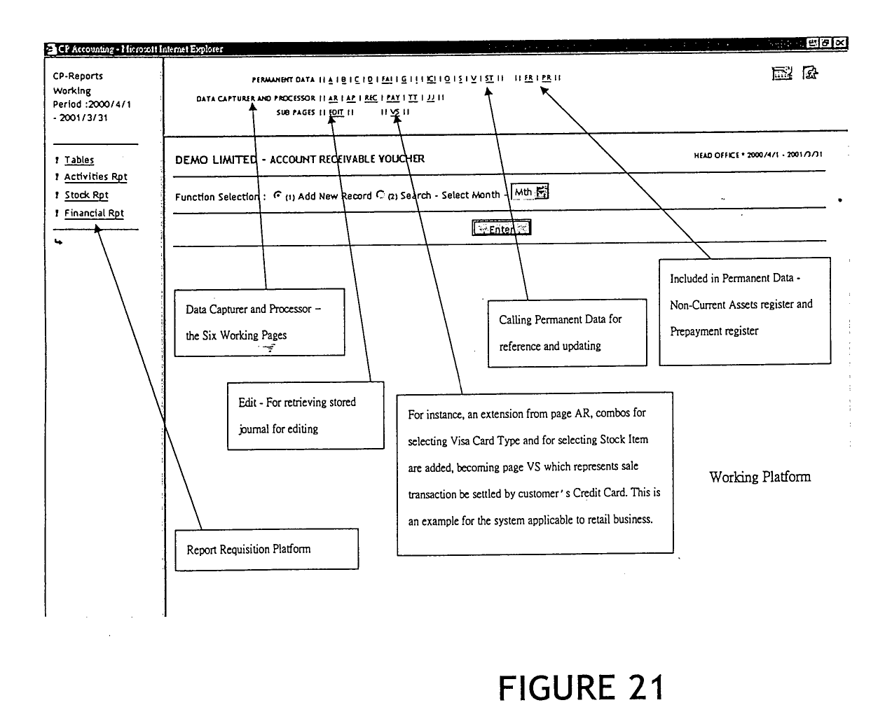

Working Platform as shown in FIG. 21—the Data Capturer and Processor, the six working pages are listed on the functions bar in abbreviation form or full wording form of the working platform. Commands for reports requisition may also be included in the functions bars. Users can select to use both the abbreviation and full forms or to use abbreviation form only. The commands for pages may be composed of meaningful wordings. By clicking the selected command, the linked working page can be opened.

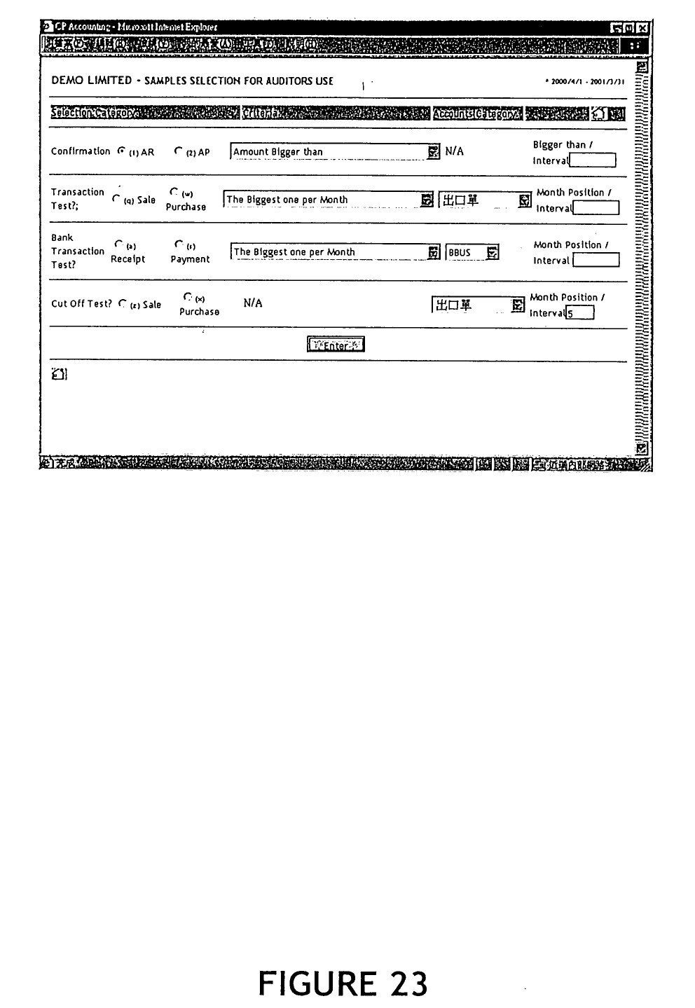

In an embodiment of the invention a user interface as shown in FIG. 23 may be incorporated for use by an internal/external auditor.

What is claimed is:

1. A method of implementing a double-entry bookkeeping performed on an internet-based accounting system comprising:
providing at least one user end having a general-purpose computer with a browser, and at least one server end having a server;
providing a communication linkage with an internet connection between the general-purpose computer and the server;
providing a program for performing bookkeeping and accounting on the server; and
maintaining a database of user identified files which are identifiable, by name and password
executing a set of procedural steps as below:
(a) creating a user interface having a data capturer and processor which composes AR; AP; Rec; Pay; TT; and JJ working pages, respectively, for performing or capturing transactions data of credit sale; credit purchase; monetary receipt; monetary payment; monetary transfer; and general transactions, which is able to be sent to the general-purpose computer for inputting transactions data;
(b) capturing data on each working page, and then clearing up necessary input cells accordingly before sending to the general-purpose computer for further input of additional transaction data in the same transactions set;
(c) following a set of procedural steps on each of the working pages, and automatically creating a record-sets group with at least two record-sets, one for recording processed data of debit record-set and one for recording processed data of credit record-set; depending on the features of each of the working pages, one of the record-sets is created as “subject (S)” and the others as “Object (O)”; each record-sets group has only one (S) with unlimited number of (O); according to the specific procedures of each page, a transaction amount is either posted into the debit or posted into the credit field of each record set exclusively, either debit record-set or credit record-set created as (S) and (O) follow the rules for debiting and crediting in each working page; any additional transaction data in the same set will simultaneously update the transaction record-set (S) of the record-sets group and create a new record-set (O) incorporating into the record-sets group record-sets group as a whole to constitute a double entry journal while complying with the Total-Debit-Equal-Total-Credit rule throughout;
(d) defining the record-set as (S) and record-set as (O) by the rules of each working page wherein record-set (S) and record-set (O) are built up based on transaction data; except for page JJ which records general transactions wherein (O) is built up based on transaction data and record-set (s) is built up with special purpose;
(e) creating with the JJ page a dummy record-set as (S) for temporarily balancing the record-sets group because the next set transaction data of the same transactions set to be input is not anticipatable to the program wherein the function of (S) in JJ page is for protection of database files from recording single entry or disordered journal entries caused by disturbance or disconnection during the transmission of data and once all transactions data in the same transactions sets have been recorded and the total debit is equal to the total credit in a same transactions record-sets group, the (S) will be automatically deleted by the program to ensure all processed data stored into the database are double-entry journals while complying with the total-debit-equal-total-credit rule throughout.
(f) converting foreign currency into local currency by adopting the appropriate exchange rates wherein the application of the function “exchange difference calculation” is included in each working page and is based on the “principal of translation of foreign currency transaction” according to general accounting practice, enabling an automatic creation of a new record-set (E) for recording data resulting from an exchange difference derived between the adoption of book rate and transaction rate according to account types involving in the record-set (S) and (O) or vice versa so that the debit or credit balance in (E) corresponds to the adverse or favor difference derived and for each additional data set be processed, this procedure repeats and updates the amount of exchange difference in existing record-set (E);
(g) executing the full procedural steps and the Debit-Equal-Credit test of each working page when a new record-sets group “(S) plus (O) together with (E), if exchange difference derived” is created or an additional transaction record-set (O) is added, the program regarding each as a separate process of the data set;
(h) converting the double entry journal into a voucher form which will take place every time following each separate process completed as stated in step (g);
(i) feeding the voucher back to the general-purpose computer on a real time basis every time completion of a process as stated in step (g) is done as to a particular user inputting transaction data;
(j) storing a double entry journal consisting record-sets group whereas each record-set consisting the identification fields of user's identity and user's business unit; account codes; input amount; currency; the converted amount in local currency in debit field or credit field; open invoice amount in case of credit sale or credit purchase transaction;
(k) storing or updating the record sets group in form of double entry journal into the designated database file in one stoke immediately after each processing wherein access is given only to an identified user;
(l) recognizing the identification fields for the user's access right and the limitations set by the program on the usage of database file be kept intact; and
(m) receiving the reporting command from each of plurality of users and then by reference to the user's identity and business unit, sorting, working out and analyzing on each of the plurality of journal records retrieved, sending out financial reports in general accounting practice and analysis to the user by way of report editor that writes report line by line word by word to the general-purpose computer browser.

2. The method of claim 1, wherein each of the six working pages has a distinguishable relationship between the transaction type and account type for debit or credit field and accordingly there is a set of standard processing procedural steps to work out the double entry journal; a double entry journal has been completed whereas the summation of all debit amounts in debit record-sets equals to the summation of all credit amounts in credit record-sets in same record-sets group:

| | |
|---|---|
| Page AR | Relationship between debiting credit receivable (S) |
| | and crediting income (O) for credit sale; |
| Page AP | Relationship between crediting credit payable (S) |
| | and debiting cost (O) for credit purchase; |
| Page Rec | Debiting monetary flow-in (S) and crediting income |
| | (O) or customer invoice settlement (O) for receipt |
| | transaction; |
| Page Pay | Crediting monetary flow-out (S) and debiting cost (O) |
| | or debiting supplier invoice settlement (O) for |
| | payment transaction; |
| Page TT | Crediting monetary flow from one monetary item (S) |
| | and debiting monetary flow to another monetary item |
| | (O) for monetary transfer transaction; |
| Page Journal | Dummy record (S) in debit/credit field and |
| | corresponding amount in credit/debit field of record- |
| | set (O) of general transaction causing change in |
| | asset, liability, income, expense or capital account. |

3. The method of claim 2, wherein each working page supports journal formation for multiple transactions in transactions set with availability of constant call back of that page until all intended transactions in same set are completed for a journal.

4. The method of claim 1, further including the step of complying with the principle of a double entry system wherein in case of a new transaction data set being processed there is created a new set of record-sets group, summation of the amount in (O₁) and the amount in E₁, amount of E₁ is negative if credit and positive if debit, equals to the amount in (S₁), and if so, a test passes and the record-sets group is stored so that a double entry journal is completed.

5. A method of claim 1, wherein when additional transaction data set is processed, a new record set (O₂) is created and existing record-sets group of same record-sets group posted previously is brought back from the database file and updated as follows:
amount in existing Record set (O₁)=A;
amount in existing Record set (S₁)=B;
amount in existing Exchange record set (E₁)=C;
amount in new record set (O₂)=D;
amount of newly derived exchange difference for adding into (E₁)=E;
amount of newly created for adding into Record set (S₁)=F;
if A+C+D+E=B+F, test pass;
the record-sets group will be updated and the journal will have:
record set (O₁) with amount A;
record set (S₁) with amount B+F;
record set ((E₁) with amount C+E;
record set (O₂) with amount D;

6. The method of claim 1, further including the step of posting close balance of each balance sheet item from one year to become the opening balance of next year; for balances other than the accounts receivable and accounts payable, each balance sheet item are grouped by way of posting balance of each business unit separately and for accounts receivable and accounts payable, balances are posting separately not only referring to each of particular business units it belongs to but also referring to open invoice by each record.

7. The method of claim 1, wherein the six working pages are reached by six different commands through clicking the desired icon on page name as listed on the functions bar of a user's work platform, wherein the functions bar is available either in both the abbreviation form and in full wording form or solely in abbreviation form when opening function pages for input or output.

8. The method of claim 1, wherein the precise user file in plurality of database files is located by recognizing the user's identity and password.

9. The method of claim 1, wherein the rights of access include stating as follows:
Level 0—report user only;
Level 1—supervisor of head office has the right to access and handle information of the head office and all business units under the head office; has the authority to combine all the financial information with all business units under the head office; and the supervisor has the right to define and delegate authority to and to set limitations on access rights of each user of each business unit;
Level 2—user of each business unit has the right to handle the accounts of the business unit, subject to the limitations set by Level 1 supervisor, certain financial information and report of that unit can be accessed and read.

10. The method of claim 1, wherein the work platform and the data capturer and processor are constructed on a transaction oriented basis such that data of a transaction input by user is according to the details of that transaction through following the guiding instructions/wordings, logical sequence and hints provided by each page, and where the program can convert them into double entry journal.

11. The method of claim 1 which further includes the step of enabling the report editor to write financial information to the browser of each of a plurality without the assistant of market available reporting tools.

12. The method of claim 1 which further includes the step of allocating the accounts code prefixes according to each type of accounts which are pre-set by system, to thereby form an account skeleton.

13. The method of claim 1 which further includes the step of establishing meaningful journal code prefixes which are pre-set by system.

14. The method of claim 1, wherein the program prepares financial indicators and ratios including liquid ratio, quick ratio, debtor turnover rate, creditor turnover rate, debt/equity ratio for balance sheet analysis; gross profit ratio and incomes and expenditures ratio analysis for profit and loss statement analysis by processing information from plurality of journals stored in the user's database file.

15. The method of claim 1, wherein a special working page is provided to an internal/external auditor which includes pre-set scopes of audit tests with pre-set series of selection criteria; responding to the command by each of plurality of users, the program retrieves from plurality of journals stored in the database file of that user; analyzing the information according to the selected test type and selected criteria; and reporting to the general-purpose computer through the report editor annexed to the program.
